(19) United States
(12) Patent Application Publication
(10) Pub. No.: US 2008/0256026 A1
(43) Pub. Date: Oct. 16, 2008

(54) Method For Optimizing And Executing A Query Using Ontological Metadata

(76) Inventor: Michael Glen Hays, Melbourne, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/873,137

(22) Filed: Oct. 16, 2007

Related U.S. Application Data
(60) Provisional application No. 60/829,767, filed on Oct. 17, 2006.
(60) Provisional application No. 60/973,612, filed on Sep. 19, 2007.

(51) Int. Cl. G06F 7/06; G06F 17/30

(52) U.S. Cl. 707/2; 707/3; 707/E17.017

(57) ABSTRACT

A method is provided for optimizing a query. The method includes providing metadata, and inputting an initial query including at least one initial class. The method further includes processing the initial query with the metadata. Additionally, the method includes obtaining an optimized query based on the processing of the initial query, where the optimized query provides at least one subsequent class based on the at least one initial class.

### CROSS-REFERENCE TO RELATED APPLICATIONS

The present application claims priority from U.S. Provisional Application No. 60/829,767 filed Oct. 17, 2006 and U.S. Provisional Application No. 60/973,612 filed Sep. 19, 2007, both of which are incorporated by reference herein.

### FIELD OF THE INVENTION

The present invention relates to queries, and more particularly, to a method for optimizing and executing a query using ontological metadata.

### BACKGROUND OF THE INVENTION

In conventional methods which execute queries, these methods typically copy data from external databases into an internal database against which the original unmodified query is run. The query is typically broken down into a query plan, which is an internally executable form. However, various challenges are introduced by the approach of these conventional methods. For example, from an ontological perspective, by copying data from the external database into an internal database, the method must now compare each additional fact copied from the external database with the existing facts in the internal database, thereby sharply reducing the efficiency of the method as the number of copied external facts increase. Additionally, even if the conventional system does copy facts from the external database, the internal database will only be “current” as of the moment that the external facts were transferred, and thus this conventional method is no longer consistent when the external database is modified. Indeed, this failure to ensure that the query plan is run against a current set of facts may lead to the breaking of queries, for example.

Accordingly, there is a need for a method for executing queries which avoids the inefficiencies of conventional methods and ensures that the query is run against a current set of facts, to achieve an accurate set of results.

### BRIEF DESCRIPTION OF THE INVENTION

In one embodiment of the present invention, a method is provided for optimizing a query. The method includes providing metadata, and inputting an initial query including at least one initial class. The method further includes processing the initial query with the metadata. Additionally, the method includes obtaining an optimized query based on the processing of the initial query, where the optimized query provides at least one subsequent class based on the at least one initial class.

In one embodiment of the present invention, a method is provided for executing an optimized query, where the optimized query is based on processing an initial query with metadata. The method includes providing the optimized query, where the optimized query includes at least one subsequent class and a respective physical table location of the at least one subsequent class within a respective data source. The method further includes providing an interface layer to access the respective data source, and obtaining data of the at least one subsequent class from the respective physical table location within the respective data source. The method further includes returning a data result based on the optimized query.

In one embodiment of the present invention, a method is provided for executing a query. The method includes parsing the query into a syntax tree, followed by identifying an initial class of the query within the syntax tree. The method further includes identifying an ontological equivalent class of the initial class, where the ontological equivalent class has a physical table located within a data source. Additionally, the method further includes identifying an attribute of the ontological equivalent class, where the attribute has data located within the physical table. More particularly, the method further includes determining if a remaining initial class requires identification of an ontological equivalent class. The method further includes obtaining the attribute data for an ontological equivalent class from the physical table within the data source. Additionally, the method includes appending each attribute data for each ontological equivalent class to a result group. The method further includes determining if a remaining ontological equivalent class requires the obtaining of the attribute data. The method further includes returning the result group in response to the query.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a flow chart illustrating an exemplary embodiment of a method for executing a query according to the present invention;

FIG. 2 is a flow chart illustrating an exemplary embodiment of a method for executing a query according to the present invention;

FIG. 3 is a flow chart illustrating an exemplary embodiment of a method for optimizing a query according to the present invention;

FIG. 4 is a flow chart illustrating an exemplary embodiment of a method for executing an optimized query according to the present invention;

FIG. 5 is a flow chart illustrating an exemplary embodiment of a method for executing a query according to the present invention;

FIG. 6 is an exemplary embodiment of a plurality of levels of database architecture according to the present invention;

FIG. 7. is an exemplary embodiment of an abstract syntax tree of an initial query according to the present invention; and

FIG. 8 is an exemplary embodiment of a query plan according to the present invention.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

FIG. 3 illustrates an exemplary embodiment of a method 300 for optimizing a query. The method 300 begins at block 301 by providing (block 302) metadata, including an upper level ontology language having a plurality of classes and data to link each subsequent class within the upper level ontology to a respective physical table within a respective data source, for example. As appreciated by one of skill in the art, the data sources may be located on an external server or a computer having a foreign IP address, for example, which is retrieved by the metadata. The method 300 further includes inputting (block 304) an initial query having at least one initial class. An example of such an initial query may be “provide the name of everything having an age, where the age is less than 21,” for example. The method 300 further includes processing (block 306) the initial query with the metadata, as further described in the embodiments of the present invention below. Finally, the method 300 includes obtaining (block 308) an optimized query based on the processing step (block 306) of the initial query, where the optimized query provides at least one subsequent class based on the at least one initial class. For example, an optimized query based on the initial query “provide the name of everything having an age, where the age is less than 21,” may be “provide the name of all people having an age, where the age is less than 21” and “provide the name of all wines having an age, where the age is less than 21.” Accordingly, in processing (step 306) the initial query, the metadata supplies ontological relationships, such as “all people are things” and “wine is a thing,” to assemble the optimized query.

The optimized query further provides a respective physical table location of the at least one subsequent class within a respective data source, such as a Microsoft sequel server located at a different physical location than the present computer processing the initial query, for example. The metadata includes an upper level ontology language having a plurality of classes and data to link each subsequent class within the upper level ontology to the respective physical table within the respective data source. As previously discussed, the upper level ontology language includes one or more ontological relationships between the plurality of classes, where at least one of the classes is an initial class within the initial query. In the example discussed above, the initial class “thing” is among the plurality of classes in the upper level ontology of the metadata. In an additional exemplary embodiment, the metadata may include an upper level ontology language with zero classes and data, and may return no data in response to the query. This metadata may be used for developing and/or writing of a database, and using the initial classes in the query in the construction of the database, for example.

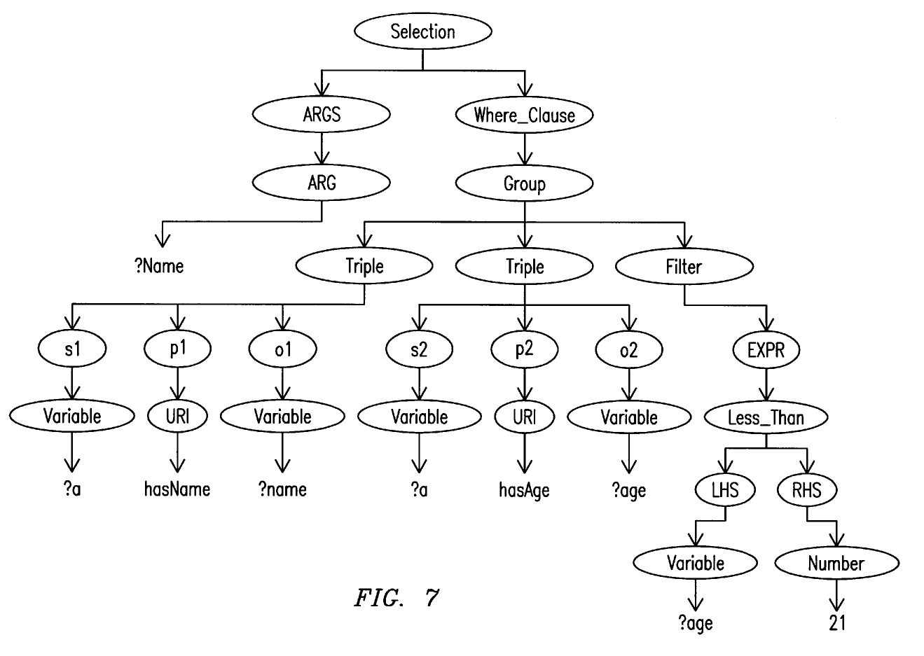

In an exemplary embodiment, the processing step (block 306) further includes parsing the initial query into one or more initial classes and one or more initial attributes of the initial class. FIG. 7 illustrates an exemplary embodiment of the parsing of the initial query discussed above: “provide the name of everything having an age, where the age is less than 21.” Additionally, the processing step (block 306) includes identifying the subsequent class as an ontological equivalent of each initial class based upon the upper level ontology language of the metadata, where the subsequent class has a respective physical table location within a respective data source. This is discussed above, in which the subsequent classes of “people” and “wine” are identified as an ontological equivalent of the initial class “things.” Additionally, the processing step (block 306) includes identifying one or more attributes of the subsequent class, where the attribute is based upon an initial attribute of the initial class. For example, the metadata identifies “name” and “age” as attributes of the subsequent classes “people” and “wine”, as common attributes to the initial attributes “name” and “age” of the initial class “things” in the initial query.

In an exemplary embodiment, the processing step (block 306) includes utilizing one or more ontological relationships of the upper level ontology language to convert the initial query into the optimized query which includes a plurality of queries. In the example discussed above, the plurality of queries making up the optimized query are “provide the names of all people having an age less than 21” and “provide the names of all wine having an age less than 21.” The plurality of queries each include a subsequent class (in the example: people, wine) which is linked to a respective physical table location within a respective data source.

In an exemplary embodiment, the processing step (block 306) involves converting a language of the initial query into a language of the optimized query, such that each language of the queries is compatible with a language of the respective data source having the respective physical table of the respective class. For example, the initial query may be provided in a SPARQL language, and the optimized query may be provided in a SQL language to be compatible with a SQL data source

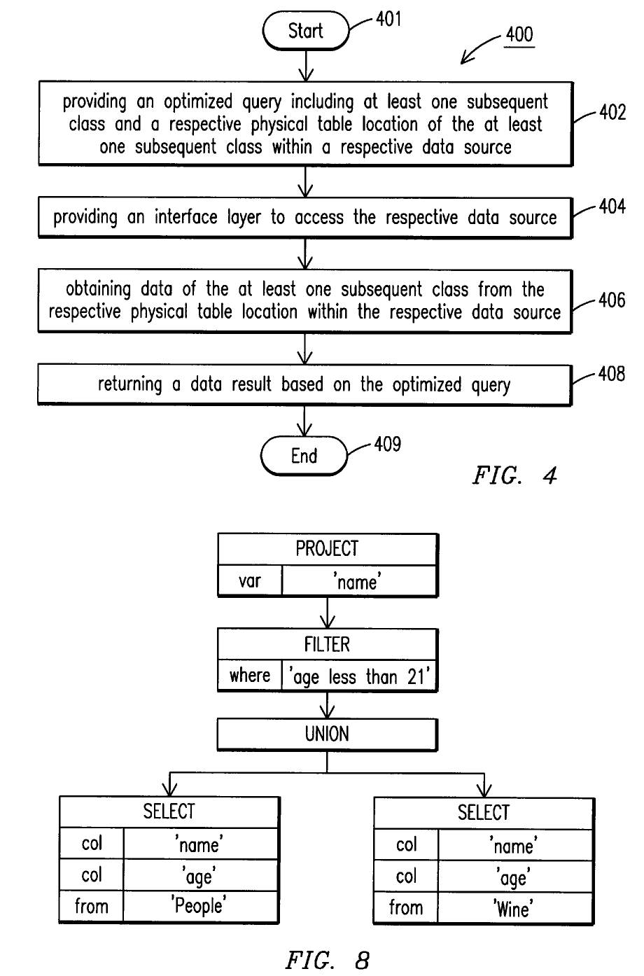

FIG. 4 illustrates an exemplary embodiment of a method 400 for executing an optimized query. As discussed above, the optimized query is based on processing (block 306) an initial query with metadata. The method 400 begins at block 401 by providing (block 402) the optimized query having one or more subsequent classes and a respective physical table location of the subsequent classes within a respective data source. The method 400 further includes providing (block 404) an interface layer to access the respective data source. This interface layer may be necessary to access some of the external data sources, such as a Microsoft sequel server located on a foreign computer, for example. The method 400 further includes obtaining (block 406) data of the subsequent classes from the respective physical table location within the respective data source. Finally, the method 400 includes returning (block 408) a data result based on the optimized query. The method 400 may include requerying each data from the data result of the optimized query against the respective physical table location to filter out data which fails to satisfy the optimized query. Additionally, the method 400 may include returning a final data result set in response to the optimized query upon requerying each data from the data result.

In an exemplary embodiment, each subsequent class may include a respective attribute included within the initial query, as discussed above. The obtaining data step (block 406) may include obtaining data of each respective attribute from the physical table location of the data source for each subsequent class. Additionally, the returning step (block 408) may include comparing the data of each attribute of each subsequent class with a filter included within the optimized query, and eliminate data which fails to satisfy the optimized query. For example, using the previous example, once the method has obtained data of the modified queries “provide the name of all people having an age less than 21” and “provide the name of all wine having an age less than 21,” the returned data may only include the names of all people and wine (without discriminating the age), and thus a filter “age less than 21” may need to be subsequently applied to the initial data result set to achieve the data results which is responsive to the initial query.

In an exemplary embodiment, the requerying step includes querying each attribute data of the subsequent class with the respective physical table location to eliminate attribute data of the subsequent class which fails to satisfy the optimized query. In the previously discussed example, the data may only return the names of all people and wine, and thus the method may requery each data result (eg. “Mike” or “California Wine”) and obtain age data from their respective physical table, in order to filter out those results which fail to meet the criteria of the initial query (“provide the names of all things having an age less than 21.”). Unlike conventional methods for responding to queries, whose queries penetrate down to a third level of storage management of database architecture (see FIG. 6), the embodiments of the present invention penetrate down to a first level or second level (query optimization, executor) of database architecture.

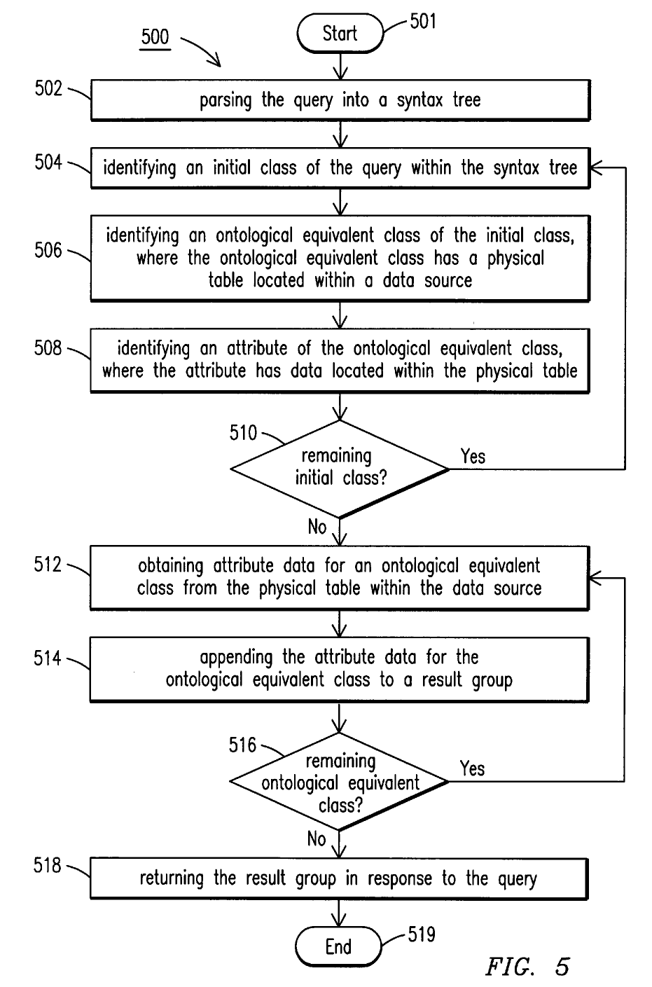

FIG. 5 illustrates a method 500 for executing a query. The method 500 begins at block 501 by parsing (block 502) the query into a syntax tree. An example of such a syntax tree is illustrated in FIG. 7. The method 500 further includes identifying (block 504) an initial class of the query within the syntax tree. Additionally, the method 500 includes identifying (block 506) an ontological equivalent class of the initial class, where the ontological equivalent class has a physical table located within a data source. The method 500 further includes obtaining (block 508) an attribute of the ontological equivalent class, where the attribute has data located within the physical table. The method 500 then determines (block 510) whether a remaining initial class requires identification of an ontological equivalent class. If so, the method 500 returns to the identifying step at block 504. If not, the method 500 continues to obtaining (block 512) the attribute data for an ontological equivalent class from the physical table within the data source. The method 500 further includes appending (block 514) each attribute data for each ontological equivalent class to a result group. The method 500 then determines (block 516) if a remaining ontological equivalent class requires the obtaining of the attribute data. If so, the method 500 returns to the obtaining step at block 512. If not, the method 500 continues to returning (block 518) the result group in response to the query, before ending at block 519.

In an exemplary embodiment of the present invention, a query optimizer takes the syntax of a query against a database and prepares it for consumption by a query executor which actually retrieves the data. Ontological systems can impose semantics on schema to define relationships between the parts of the schema and the instances stored within the schema. This can translate to changes in the physical layer, or in an adaptation of the query layer. Certain logical relationships may cause an increase in complexity, both in space and in time. An embodiment of the present invention separates the instance data from the schema and utilizes an entailment document to join the two. The optimizer can analyze the query for ways to filter data earlier in the query plan. This embodiment specifies that the optimizer creates one or more adapted queries for a given query which it then imposes on data stores which hold the instance data. It will then join those result sets together and present them to the original query as though the instances had always. Some basic discussion of the underlying subject matter of the present invention includes: “The SPARQL Handbook” by Janne Saarela. ISBN 978-0123695475, “Compilers: Principles, Techniques, and Tools (2nd Edition)” by Alfred V. Aho, Monica S. Lam, Ravi Sethi, and Jeffrey D. Ullman. ISBN-13: 978-0321486813, and “Database Management Systems” by Raghu Ramakrishnan and Johannes Gehrke. ISBN-13: 978-0071230575, all of which are incorporated by reference herein.

In an additional exemplary embodiment, a computer implemented method is provided for taking a query and adapting it to one or more queries (in one or more different languages), using an ontological document to create more discriminating queries, executing those queries against their own data stores, merging the result sets into a single result set, and optionally requerying that result set by using the original query.

In an exemplary embodiment of the present invention, a method is provided to allow the physical databases to retain their data. This permits one to relegate the complexity of storage management to solutions which have already proven themselves. When making queries against them, there is no presumption of ownership or control over those storage units. The exemplary embodiment involves analyzing the incoming query, instrumenting it with new physical operators which trigger instance retrieval from those external sources and assembling a new cohesive document which contains all of the instance data that could appear in the solution. The query is then applied to this cohesive unit without instrumentation and the true result is obtained. Description logics can accompany the query to allow semantic relationships to be used when considering what instance data is relevant.

An effective procedure to accomplish the above may involve taking a query, parsing it, and using the information that we have gathered about the query to populate some minimal ontological document with the triples that will contain the answer for the user. The query can be in any query language. Although some embodiments of the present invention discuss the SPARQL language, the SQL and XQuery languages, the present invention is not limited to these languages, and includes all query languages.

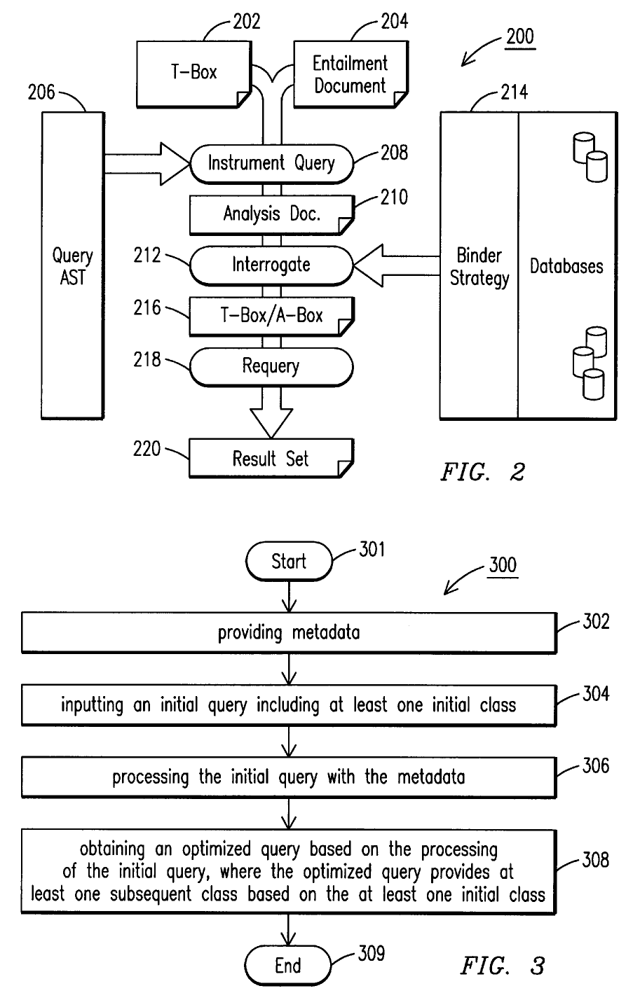

FIG. 2 illustrates an exemplary embodiment of a method 200 according to the present invention. The user supplies us with an entailment document 204 and T-Box 202 data. The entailment document 204 is a set of frame definitions which specify what their instances look like, and detail explicitly how to retrieve those instances from some external source.

The entailment document 204 contains the frame definitions, and for each definition, describes how instances of those definitions will be fetched from the federation of databases. The T-Box 202 is optional, but describes how the frames logically relate to one another. Both of these documents are used to instrument the query 206 at the step 208 and retrieve instance data by interrogating 212 the external data source(s). Once all of the entailment data has been retrieved 216, the queries can be re-run 218 against the data to retrieve a resulting set of data 220. An example of an entailment document is as follows:

<?xml version=“1.0”?>
<!DOCTYPE name [
<!ENTITY demo “http://modusoperandi.com/jena/demo#”>
<!ENTITY results “http://jena.hpl.hp.com/demoResults#”>
<!ENTITY unnamed “http://www.owl-ontologies.com/unnamed.owl#”>
<!ENTITY mo “http://modusoperandi.com/jena#”>
]>
<rdf:RDF

xmlns:owl=“http://www.w3.org/2002/07/owl#”

xmlns:rdf=“http://www.w3.org/1999/02/22-rdf-syntax-ns#”
xmlns:rdfs=“http://www.w3.org/2000/01/rdf-schema#”
xmlns:unnamed=“http://www.owl-ontologies.com/unnamed.owl#”
xmlns:demo=“&demo;”
xmlns:mo=“&mo;”
xmlns=“&demo;”
xml:base=“&demo;”>
<mo:BoundEntity rdf:ID=“Wine”>

<mo:bindFunction>JDBC</mo:bindFunction>

<mo:connection>jdbc:mysql://localhost:3306/wine_repository</mo:connect

ion>

<mo:username>ontologyuser</mo:username>
<mo:password>ontologyuser</mo:password>
<mo:driver>com.mysql.jdbc.Driver</mo:driver>
<mo:tablename>tblWine</mo:tablename>
<mo:mapslot>hasName:Name</mo:mapslot>
<mo:mapslot>hasAge:Age</mo:mapslot>
<mo:mapslot>hasRegion:Region</mo:mapslot>
<mo:hasSlot>hasName</mo:hasSlot>
<mo:hasSlot>hasAge</mo:hasSlot>
<mo:hasSlot>hasRegion</mo:hasSlot>

</mo:BoundEntity>
<mo:BoundEntity rdf:ID=“People”>

<mo:bindFunction>JDBC</mo:bindFunction>

<mo:connection>jdbc:mysql://localhost:3306/jenawave_tests</mo:connect

ion>

<mo:username>ontologyuser</mo:username>
<mo:password>ontologyuser</mo:password>
<mo:driver>com.mysql.jdbc.Driver</mo:driver>
<mo:tablename>tblPeople</mo:tablename>
<mo:mapslot>hasName:Name</mo:mapslot>
<mo:mapslot>hasAge:Age</mo:mapslot>
<mo:mapslot>hasAddress:Address</mo:mapslot>
<mo:mapslot>hasFather:Father</mo:mapslot>
<mo:mapslot>hasMother:Mother</mo:mapslot>
<mo:hasSlot>hasName</mo:hasSlot>
<mo:hasSlot>hasAge</mo:hasSlot>
<mo:hasSlot>hasAddress</mo:hasSlot>
<mo:hasSlot>hasFather</mo:hasSlot>
<mo:hasSlot>hasMother</mo:hasSlot>

</mo:BoundEntity>
<mo:BoundEntity rdf:ID=“Places”>

<mo:bindFunction>JDBC</mo:bindFunction>

<mo:connection>jdbc:mysql://localhost:3306/jenawave_tests</mo:connect

ion>

<mo:username>ontologyuser</mo:username>
<mo:password>ontologyuser</mo:password>
<mo:driver>com.mysql.jdbc.Driver</mo:driver>
<mo:tablename>tblPlaces</mo:tablename>
<mo:mapslot>hasName:Name</mo:mapslot>
<mo:mapslot>hasAge:Age</mo:mapslot>
<mo:mapslot>hasLatitude:Latitude</mo:mapslot>
<mo:mapslot>hasLongitude:Longitude</mo:mapslot>
<mo:hasSlot>hasName</mo:hasSlot>
<mo:hasSlot>hasAge</mo:hasSlot>
<mo:hasSlot>hasLatitude</mo:hasSlot>
<mo:hasSlot>hasLongitude</mo:hasSlot>

</mo:BoundEntity>
<demo:Employee>

<rdfs:subClassOf>

<demo:People>

</rdfs:subClassOf>

</demo:Employee>

</rdf:RDF>

Aside from slots, the entailment document also attaches to the frame description information about how to retrieve that external data. Credentials, filters, aliases, and anything else is a particular “type” of binder 214 might may be needed to access the external data source(s). The “type” of the binder refers to the strategy with which that binder will fetch data. Any system which can expose Frame instances based on a Frame definition and details from the query language can by integrated. This could be Wave technology, JDBC, persistent XML, or any other source which has been adapted for use.

The T-Box 202 is user supplied and can include any ontological data that will be considered before and after running the query. By using ontological relationships, equivalence and subsumption classes can be specified. The T-Box 202 can specify equivalence relationships between slots. It can create restrict relationships. While not all of this data will be considered by the optimizer, it is available for consideration. For example, T-Box data has been defined inline with our binding document. In an exemplary embodiment, T-box data may state that an Employee is a subclass of People. To our system, if A is a subclass of B, where A and B are a class of object, then if some thing is an instance of A, then logically, it is also an instance of B. This means that in a typical query (we'll use SPARQL language for example), one can ask for an Employee with the name “Schmidt”, the query optimizer will discover that the People class is considered when answering the user's question. In fact, it is not really necessary to specify the class unless we are trying to restrict data to a small class. Simply stating that someone wants something with a name of “Schmidt” will allow the query optimizer to deduce that such a thing could be a Person (or a Place or a Wine) and will query the appropriate binder.

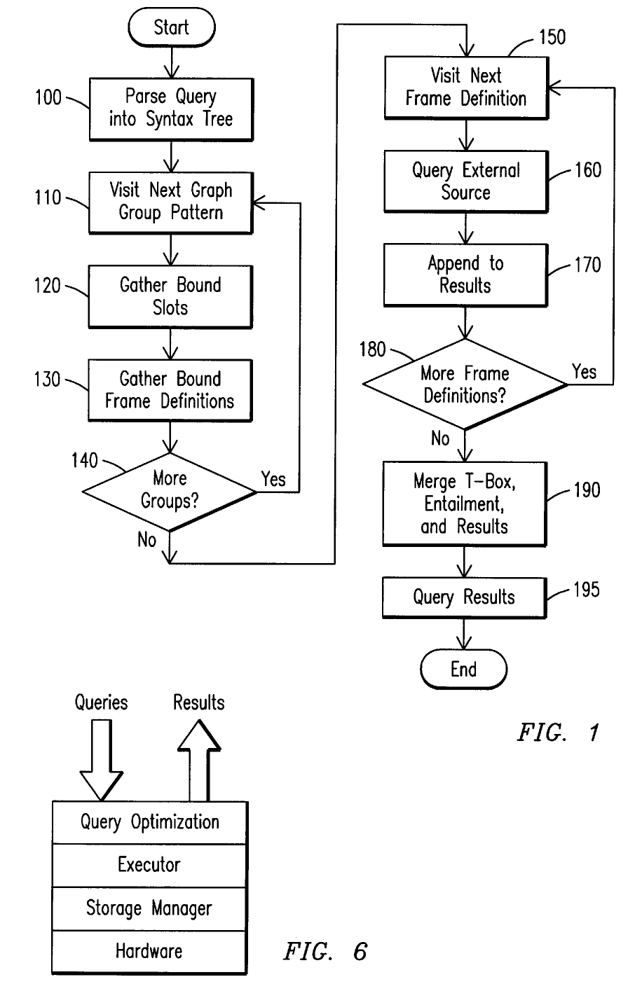

FIG. 1 illustrates an exemplary embodiment of a method according to the present invention. The query is initially parsed into a syntax tree (step 100). For each Group Graph Pattern within the query (step 110), look at the relationship specified in the basic graph patterns (there may be more than one basic pattern in the group, so consider them all). For each relationship, determine if it is a boundslot. From the semantics of the T-Box if the relationship appears as a property of a slot definition, or is a subclass or equivalent to a property that appears as a slot definition, add the triple pattern to the set BoundSlots (step 120). Using the definition of a basic graph pattern, for each unique S in the triple patterns in BoundSlots, locate all Frame Definitions which define slots for all R values given that S. Add this frame definition to the set of BoundFrameDefinitions if it does not already exist, and add as its child the value of S (step 130). Iterate through each BoundFrameDefinition (step 140) and prepare a query in the underlying language of that Frame Definition (for instance, if the instances are stored in a SQL database, then a SQL query is formed). If more than one S is the child of a Frame Definition, then the potential for some Join operation is possible. If the triples which contributed the S has an O which matches an O for another S on the same Frame Definition, then an inner join should be performed to limit the resulting set. If the triples which contributed the S has an O which appears within a value constraint, then a filter should be placed on the query to limit the result set (e.g., for a SQL statement, this would assume a WHERE clause). It may be that not all expressions in the Value Constraint language can be mapped onto a constraint clause in the target language (expressed by the frame definition), in which case superfluous triples may be returned. Execute that query (step 160) and merge its results with our running list of entries (step 170). Their results will be merged with both the T-Box data and the Entailment document (step 190) at which point the query will be run a final time against these results. The answer to this final query is the answer to the problem (step 195).

In step 100 of parsing the query into the syntax tree, one may need a parser that understands the source query language. There are many references on writing parsers (from lexical analysis to producing a complex syntax tree to producing an AST), including “Compilers: Principles, Techniques, and Tools (2nd Edition)” by Alfred V. Aho, Monica S. Lam, Ravi Sethi, and Jeffrey D. Ullman, which is incorporated by reference herein. For our example, in considering SPARQL as a source language, a specification is provided on the internet at http://www.dajobe.org/2005/04-sparql/ or “The SPARQL handbook”, previous cited, which is incorporated by reference herein. For examples, the intermediate representation will be in XML. This will permit proving this technique using data structures that can be captured in print. In a typical AST, parsers are written to capture text into a context free grammar, and the rules in that grammar may be complex, and the tree that is generated has many more nodes than may be of use. The query is kept relatively simple in order to establish the technique, understanding that these concepts can be extended to far more complex queries. In an example of considering the following SPARQL query:

SELECT ?name
WHERE
{

?a hasName ?name.
?a hasAge ?age.
FILTER (?age > 21).

}

This query might generate the following abstract syntax tree as illustrated in FIG. 7.

After parsing the query into the syntax tree, the exemplary embodiment of a method illustrated in FIG. 1 involves providing an ontology which details the classes and their attributes. So long as one can query this ontology for information about what classes are available and which attributes belong to that class, it is immaterial how that data is stored. For our example, an OWL file provides a few classes arranged in a hierarchy, as well as several attributes which belong to those classes. This information gives semantic context to expand the query the user has written to “fill in the blanks” when rewriting this query into the target language. There may be no information in the ontology. In this case, the target language will typically have no more information than the source language, and so the method simply changes syntax at that point (in this manner, without loss of generality, one could change C++ code into Pascal code, since no dynamic semantics are required to make that translation). For this example, one will also include what we will call “entailment” elements. These are basic classes and attributes which will trigger one to actually complement the translated query with statements that do the actual work. Consider the following OWL document.

After providing the ontology, the method illustrated in FIG. 1 includes querying the ontology using information discovered in the AST to provide details while generating the target query. To keep this transformation as generic as possible, one will not generate the target query directly (although it is possible, it is not as flexible). Instead, one will generate a Query Plan. A query plan, an example of which is illustrated in FIG. 8, is a set of steps that will yield data to the user (this data is hopefully the answer to the user's query). A query plan may be analogized as a tree structure, where the nodes of the tree are operations that will be executed. Data flows upwards from the leaves of the tree to the head of the tree as nodes are evaluated bottom-up. A reference discussing query plan design and relational algebra (which defines all of the operators that we are using in this example), is “Database Management Systems” by Raghu Ramakrishnan and Johannes Gehrke, which is incorporated by reference herein. In the previously discussed example of “provide the names of all things having an age less than 21,” one looks up the attributes “hasName” and “hasAge”. While there are three classes that have the attribute “hasName” (people, places, and wine), only two of those also have the attribute “hasAge” (people and wine). Hence, “places” is immediately pruned from consideration. Ultimately, instances of BoundEntity in our OWL file was used to discriminate logical classes from those classes which actually resolve into a query into the back end data stores. A BoundEntity contains metadata describing how to physically connect to the data store, and there is no need to consider any class which for which the BoundEntity is not a subclass. The metadata also provides definitions for the “slots”, or attributes, which are contained within that entity. When a source query contains references to attributes which are subclasses of these bound slots, it provides a trigger to include the corresponding BoundEntity in our query. Hence, the first pass of the query plan is as illustrated in FIG. 8.

The operations are:
SELECT—This operation retrieves data from an external data store as a collection of triples.
FILTER—This operation slices a dataset horizontally. This means that it will remove triples from its collection.
UNION—This operation takes all triples that it receives and creates a single set of triples. This is a very simple operation, but important, as most operators require a single set of triples.
PROJECT—This operation slices a dataset vertically. This means that it will not remove any triples, but it will remove some columns from all of the triples in its collection.

This set of operations is not exhaustive, but it lays the groundwork for explaining the process. With a query plan, the method can re-encode that into any target language as appropriate (as long as there is some computationally equivalent set of steps in the target language). One uses the metadata to help lay out the syntax.

In our case we will turn this query plan into the following XQuery:

<rowset>
{
FOR EACH $p in doc(‘people.xml’)//row, doc(‘wine.xml’)//row
WHERE $p/@age > 21
RETURN

<row name=”{$p/name}”/>

}
</rowset>

In the interrogation step of the method illustrated in FIG. 1, since there is a target query, this can be executed against the data storage. The data is returned as a set of triples. The projection elements of the Query Plan provides us the names of the columns of our dataset.

An optional requery step may be utilized in the method as illustrated in FIG. 1. At this point, the triples could be reconstituted as a new set of data which could be required. This is optional, but since the metadata may describe recursive relationships, it is important to realize that many target query languages (such as SQL) do not support recursive elements and the query processor would need to take on this responsibility.

Based on the foregoing specification, the above-discussed embodiments of the invention may be implemented using computer programming or engineering techniques including computer software, firmware, hardware or any combination or subset thereof, wherein the technical effect is to execute a query. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A method for optimizing a query, comprising:
providing metadata;
inputting an initial query;
processing the initial query with the metadata; and
obtaining an optimized query based on said processing of the initial query, said optimized query providing at least one subsequent class based on said at least one initial class.

2. The method of claim 1, wherein said optimized query further provides a respective physical table location of said at least one subsequent class within a respective data source.

3. The method of claim 2, wherein said metadata comprises an upper level ontology language including a plurality of classes and data to link said at least one subsequent class within said upper level ontology to said respective physical table within said respective data source.

4. The method of claim 2, wherein said metadata comprises an upper level ontology language including zero classes and data, said metadata being provided to develop at least one database.

5. The method of claim 3, wherein said upper level ontology language comprises at least one ontological relationship between said plurality of classes, wherein one of said classes is said initial class within said initial query.

6. The method of claim 3, wherein said processing comprises:
parsing said initial query into said at least one initial class and at least one initial attribute of said initial class;
identifying said subsequent class as an ontological equivalent of each initial class based upon said upper level ontology language of said metadata, said subsequent class having said respective physical table location within said respective data source; and
identifying at least one attribute of said subsequent class, said at least one attribute based upon said at least one initial attribute.

7. The method of claim 5, wherein said processing comprises utilizing said at least one ontological relationship of said upper level ontology language to convert said initial query into said optimized query comprising a plurality of queries, said plurality of queries each including said at least one subsequent class linked to said respective physical table location within said at least one data source.

8. The method of claim 7, wherein said processing converts a language of said initial query into a language of said optimized query, such that each of said queries language is compatible with a language of said respective data source having said respective physical table of the respective class.

9. The method of claim 8, wherein said initial query is provided in a SPARQL language, said optimized query is provided in a SQL language to be compatible with a SQL data source

10. A method for executing an optimized query, said optimized query based on processing an initial query with metadata, said method comprising:
providing said optimized query, said optimized query including at least one subsequent class and a respective physical table location of said at least one subsequent class within a respective data source;
providing an interface layer to access said respective data source;
obtaining data of said at least one subsequent class from said respective physical table location within said respective data source; and
returning a data result based on said optimized query.

11. The method of claim 10, further comprising:
requerying each data from said data result of said optimized query against said at least one physical table location to filter out data which fails to satisfy the optimized query; and
returning a final data result set in response to said optimized query.

12. The method of claim 10, wherein said at least one subsequent class includes at least one respective attribute included within said initial query, said obtaining data includes obtaining data of each respective attribute from said physical table location of said data source for each subsequent class.

13. The method of claim 12, wherein said returning said data result comprises comparing said data of each attribute of each subsequent class with a filter included within said optimized query, said comparing for eliminating data which fails to satisfy said optimized query.

14. The method of claim 11, wherein said requerying comprises querying each attribute data of said subsequent class with said respective physical table location to eliminate attribute data of said subsequent class which fails to satisfy said optimized query.

15. A method for executing a query, comprising:
parsing the query into a syntax tree;
identifying an initial class of said query within said syntax tree;
identifying an ontological equivalent class of said initial class, said ontological equivalent class having a physical table located within a data source;
identifying an attribute of said ontological equivalent class, said attribute having data located within said physical table;
determining if a remaining initial class requires identification of an ontological equivalent class;
obtaining said attribute data for an ontological equivalent class from said physical table within said data source;
appending said attribute data for said ontological equivalent class to a result group;
determining if a remaining ontological equivalent class requires the obtaining of the attribute data; and
returning said result group in response to said query.

16. The method of claim 15, further comprising:
requerying said result group by comparing each attribute data for each ontological equivalent class in said result group with said respective physical table location to eliminate attribute data of said ontological equivalent class which fails to satisfy said optimized query.
